(19) United States
(12) Patent Application Publication
(10) Pub. No.: US 2026/0336075 A1
(43) Pub. Date: Oct. 29, 2026

(54) MECHANICAL TORQUE WRENCH

(71) Applicant: Bobby Hu, Taichung City (TW)

(72) Inventor: HSIEN-CHIEH HU, Taichung City (TW)

(21) Appl. No.: 19/234,330

(22) Filed: Jun. 11, 2025

(30) Foreign Application Priority Data
Apr. 29, 2025 (TW) 114116078

(51) Int. Cl. B25B 23/142; B25B 23/14

(52) U.S. Cl. CPC B25B 23/1427; B25B 23/141

(57) ABSTRACT

A mechanical torque wrench includes a main body, an actuating device having a long rod and a short rod inserted into the main body, a torque disengagement device between the long rod and the short rod and having a disengagement member pivotally disposed on the long rod, and a torque adjustment device on the main body and having a moving seat and an adjustment member. The long rod defines a virtual transverse axis. The disengagement member extends toward the virtual transverse axis to be optionally abutting against the short rod. When a force applied reaches a preset value, the disengagement member is disengaged from the short rod. The moving seat supports one end of the disengagement member away from the short rod. The adjustment member is operable to drive the moving seat to move, thereby changing the force of the disengagement member abutting against the short rod.

### BACKGROUND OF THE DISCLOSURE

### 1. Field of the Disclosure

The present disclosure relates to torque wrenches, and more particularly, to a mechanical torque wrench.

### 2. Description of the Related Art

Patent US10,618,150B2 disclosed a “Torque Wrench” featuring a head, a torque adjustment assembly, and a main beam and secondary beam disposed within the handle thereof. The main beam is longer than the secondary beam, and both beams are fixed to the head, so as to rotate along with it. The main beam and secondary beam are releasably connected through a spring-biased trigger, with a trigger actuator coupled to the handle and arranged jacent to the trigger. When the force applied by the torque wrench reaches a preset torque value, the trigger actuator contacts the trigger on the main beam, causing a torque release. Therefore, the trigger actuator is a necessary component of the torque wrench. Also, the torque adjustment assembly of the wrench shifts the main beam away from the trigger actuator through engagement between multiple gears and racks for setting the torque value. However, the torque adjustment assembly comprises numerous different parts, making the manufacturing and assembly of a complex and troublesome process.

Also, patent US11,534,898B2 disclosed a Torque Wrench adopting a different adjustment method. The torque adjustment screw is arranged on the lateral side of the handle, making it inconvenient for adjustment during use. Similarly, the torque wrench still carries out the torque release process using a screw-like trigger.

Also, patent TWI715518B disclosed a torque wrench whose torque adjustment assembly is positioned on the lateral side of the first body. Similar to the aforementioned torque wrenches, this torque wrench fails to meet the convenience of use. Further, the torque structure thereof still requires a screw-like release part to perform the torque release process.

### SUMMARY OF THE DISCLOSURE

To improve the issues above, the present disclosure provides a mechanical torque wrench having a disengagement member optionally abutting against the short rod. When the force applied reaches the preset torque value, the disengagement member is disengaged from the short rod, so as to swing from the abutting position to the disengagement position without need of interference of other components, thereby interrupting the torque.

For achieving the aforementioned objectives, an embodiment of the present disclosure provides a mechanical torque wrench comprises:
a main body having a first end and a second end arranged away from the first end along a first axis, with an accommodation space formed between the first end and the second end;
an actuating device having a driving portion and a long rod and a short rod arranged in opposite to the driving portion, the driving portion being rotatable along a second axis perpendicular to the first axis to drive a fastener, the long rod and the short rod inserted into the accommodation space from the first end, the long rod defining a virtual transverse axis, the short rod having a first abutting end disposed away from the driving portion;
a torque disengagement device disposed between the long rod and the short rod and having a disengagement member, the disengagement member pivotally disposed on the long rod along a third axis parallel to the second axis so as to be swingable between an abutting position and a disengagement position, the third axis arranged perpendicular to the virtual transverse axis, the disengagement member having a second abutting end extending toward the short rod adjacent to the virtual transverse axis to be optionally abutting against the first abutting end; when a force applied by the mechanical torque wrench reaches a preset torque setting value, the second abutting end is disengaged from the first abutting end of the short rod, such that the disengagement member swings from the abutting position to the disengagement position; and
a torque adjustment device disposed on the main body and having a moving seat and an adjustment member, the moving seat slidably disposed in the accommodation space to support an end of the disengagement member away from the second abutting end, the adjustment member rotatably disposed between the moving seat and the main body along a fourth axis parallel to the third axis, the adjustment member exposed on one side of the main body and rotatably operable to drive the moving seat to move along a direction parallel to the first axis, thereby changing a force with which the second abutting end abuts against the first abutting end.

With such configuration, when the force applied by the mechanical torque wrench reaches a preset torque setting value, the disengagement member and the short rod can are disengaged, without the need for additional components, so as to eliminate the additional components and assembly steps thereof, thereby simplifying the structure and improving the precision performance of the mechanical torque wrench.

### BRIEF DESCRIPTION OF THE DRAWINGS

FIG. 1 is a perspective view of the mechanical torque wrench in accordance with an embodiment of the present disclosure.

FIG. 2 is an exploded view of the mechanical torque wrench in accordance with an embodiment of the present disclosure.

FIG. 3 is a cross-sectional view taken along line A-A in FIG. 1, illustrating the long rod and the short rod disposed in the first fixing hole and the second fixing hole.

FIG. 4 is a cross-sectional view taken along line B-B in FIG. 1, illustrating the brake device at the brake position.

FIG. 5 is a cross-sectional view taken along line C-C in FIG. 1, illustrating the support portion of the disengagement member abutting against one end of the inclined slot away from the torque indicator, with the torque setting value set at the maximum.

FIG. 6 is a partially enlarged view of FIG. 5.

FIG. 7 follows FIG. 5 and is a schematic view of the wrenching status of the mechanical torque view, illustrating the disengagement member disengaged from the short rod.

FIG. 8 is a partial longitudinal sectional view of the mechanical torque wrench, illustrating the brake device at the release position.

FIG. 9 is a partial transverse section view, illustrating the support portion of the disengagement member abutting against one end of the inclined slot adjacent to the torque indicator, with the torque setting value set at a small value.

FIG. 10 is a graph illustrating the correlation between the torque setting value and the actual torque value of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

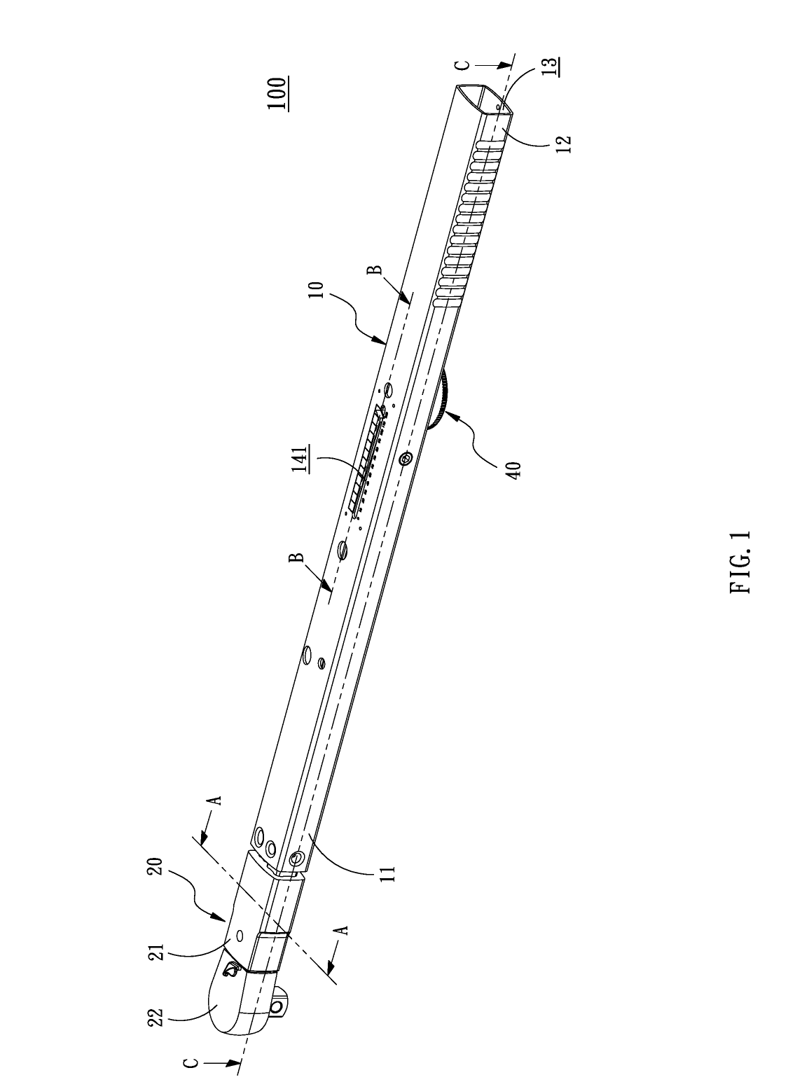

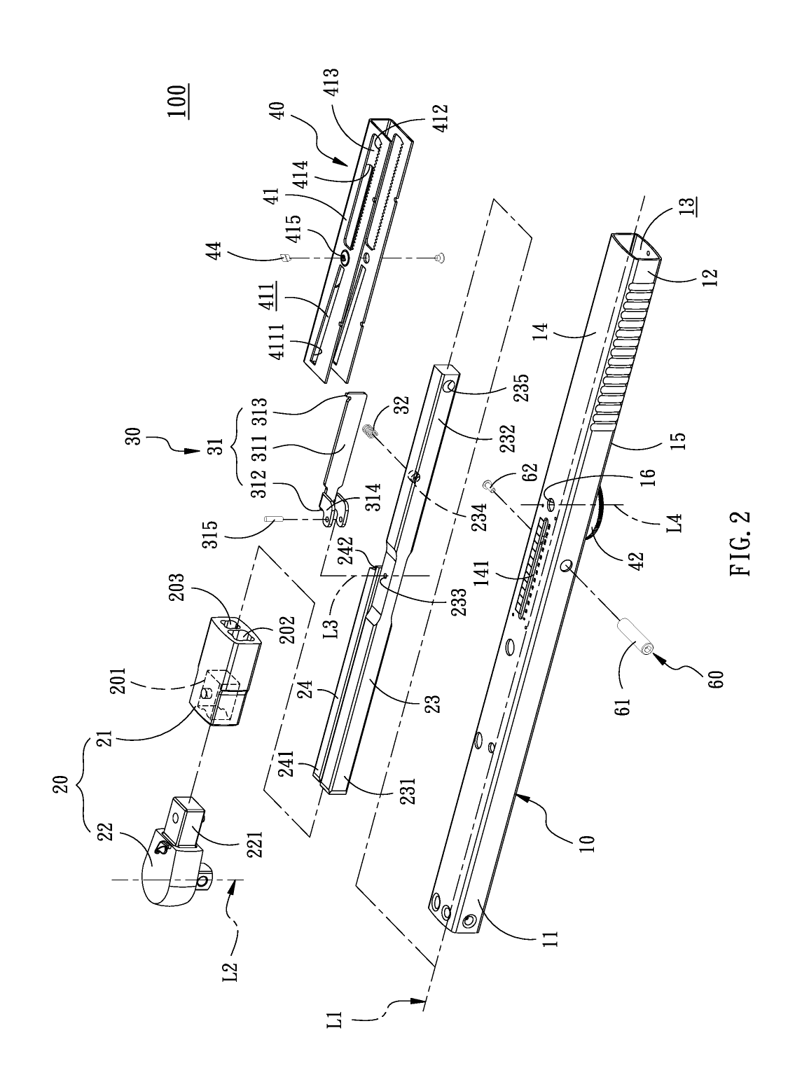

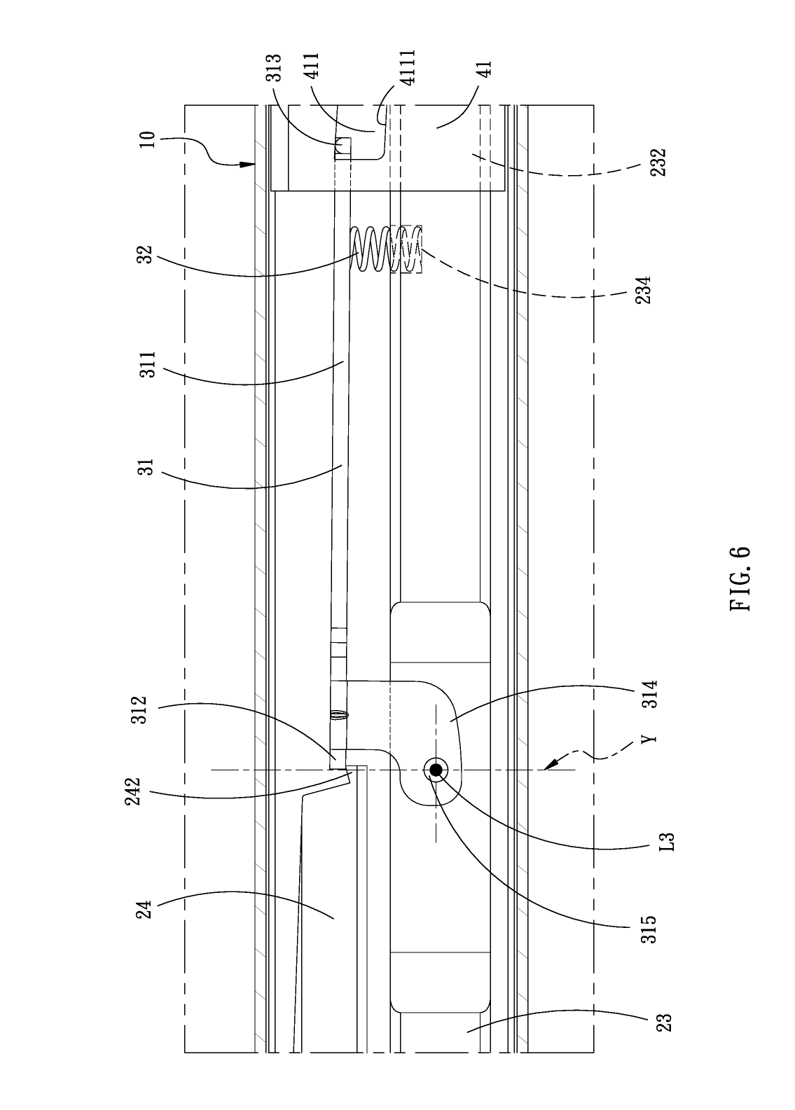

Referring to FIGS. 1-9 , the present disclosure provides a mechanical torque wrench 100, comprising a main body 10, an actuating device 20, a torque disengagement device 30, and a torque adjustment device 40.

The main body 10 is formed in a long rectangular hollow shape. The main body 10 has a first end 11 and a second end 12 arranged away from the first end along a first axis L 1. The second end 12 configured to be gripped for applying force. An accommodation space 13 is formed between the first end 11 and the second end 12. The main body 10 comprises a top face 14 and an oppositely disposed bottom face 15. A penetration hole 16 is disposed between the first end 11 and the second end 12. The penetration hole 16 extends along a direction perpendicular to the first axis L1 (i.e., a fourth axis L 4), and is open to both the bottom face 15 and the top face 14 of the main body 10. The top face 14 of the main body 10 has a scale hole 141 disposed along a direction parallel to the first axis L1, wherein the scale hole 141 is in communication with the accommodation space 13.

The actuating device 20 has an actuating member 21, a driving portion 22, a long rod 23, and a short rod 24. The actuating member 21 has an engagement groove 201, and the driving portion 22 has an engagement block 221 removably engaged with the engagement groove 201. The long rod 23 and the short rod 24 are fixed to one end of the actuating member 21 and arranged in opposite to the driving portion 22. Also, the free end of the long rod 23 and the short rod 24 are inserted into the accommodation space 13 from the first end 11. When in use, the driving portion 22 rotates along a second axis L 2 perpendicular to the first axis L1 to drive a fastener.

In the embodiment, the actuating member 21 comprises a first fixing hole 202 and a second fixing hole 203 disposed in opposite to the engagement groove 201 that are arranged in parallel and not in communication with each other. Both the first fixing hole 202 and the second fixing hole 203 have a square shaped sectional face.

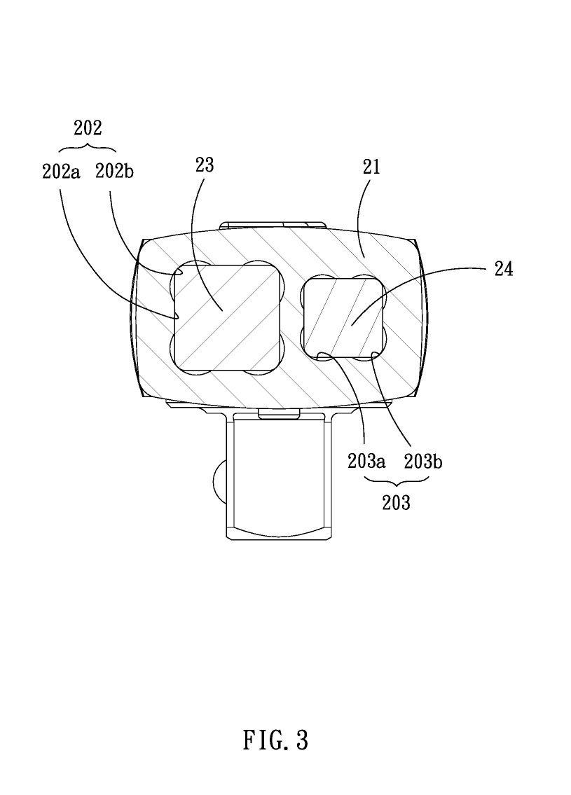

The long rod 23 has a first fixed end 231 and a distal end 232 arranged away from the first fixed end 231 and the actuating member 21. The first fixed end 231 of the long rod 23 is inserted into the first fixing hole 202 to be positioned therein. The long rod 23 defines a virtual transverse axis Y. The short rod 24 has a second fixed end 241 and a first abutting end 242 arranged away from the second fixed end 241. The second fixed end 241 is inserted into the second fixing hole 203 to be positioned therein. Both the first fixed end 231 and the second fixed end 241 have a square shaped sectional face. Referring to FIG. 3, the first fixing hole 202 has four first abutting faces 202 a therein, which are interconnected by a first arc groove 202b. The first abutting faces 202a abut against four peripheral sides 230 of the first fixed end 231 of the long rod 23. The second fixing hole 203 has four second abutting faces 203a therein, which are interconnected by a second arc groove 203b. The second abutting faces 203a abut against four peripheral sides 240 of the second fixed end 241 of the short rod 24. With such configuration, the long rod 23 and the short rod 24 are supported and secured by the first fixing hole 202 and the second fixing hole 203, so as to maintain a tightly fitted status and precisely control the positions of the long rod 23 and the short rod 24 combined to the actuating member 21.

In another embodiment, the first end 11 of the main body 10 comprises a plurality of positioning protrusions 1 11 protruding from the accommodation space 13. The positioning protrusions 111 abut against the peripheral sides 230 of the long rod 23 and the peripheral sides 240 of the short rod 24, thereby positioning the long rod 23 and the short rod 24 with respect to the accommodation space 13 and preventing deviation therefrom.

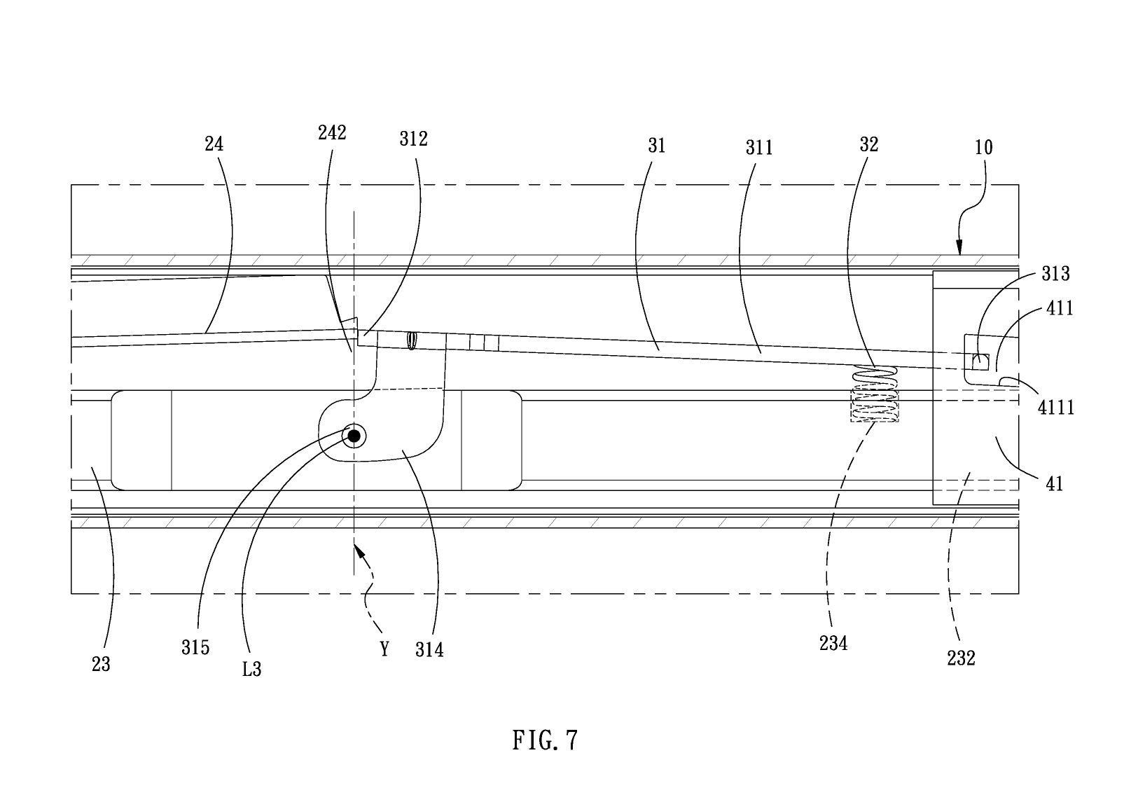

The torque disengagement device 30 is disposed between the long rod 23 and the short rod 24. The torque disengagement device 30 has a disengagement member 31 and an elastic member 32. The disengagement member 31 has a body portion 311 formed in an elongate plate shape, with a second abutting end 312 disposed at one end of the body portion 311, and an support portion 313 formed at the other end. The support portion 313 transversely extends from the body portion 311 and has an arc shaped sectional face. In another embodiment, the support portion 313 has a semi-circularly shaped sectional face (as shown in FIG. 7 ). Also, the disengagement member 31 has an ear portion 314 adjacent to the second abutting end 312.

The disengagement member 31 is pivotally disposed on the long rod 23 along a third axis L 3 parallel to the second axis L2, so as to be swingable between an abutting position and a disengagement position. The third axis L3 is perpendicular to the virtual transverse axis Y. The second abutting end 312 extends toward the short rod 24 adjacent to the virtual transverse axis Y to be optionally abutting against the first abutting end 242. When a force applied by the mechanical torque wrench 100 reaches a preset torque setting value, the second abutting end 312 is disengaged from the first abutting end 242 of the short rod 24, such that the disengagement member 31 swings from the abutting position to the disengagement position, interrupting the torque transmission and achieving the preset torque setting value.

In the embodiment, the disengagement member 31 is pivotally mounted in a pivot hole 233 of the long rod 23 through a pin member 315, so that the disengagement member 31 swings between the abutting position and the disengagement position with respect to the long rod 23.

In another embodiment, the first abutting end 242 of the short rod 24 extends beyond the virtual transverse axis Y, and the second abutting end 312 of the disengagement member 31 extends to the virtual transverse axis Y without crossing the virtual transverse axis Y, such that the second abutting end 312 is approximately flush with the virtual transverse axis Y at the abutting position. Therein, when the disengagement member 31 and the short rod 24 are at the abutting position, the vertical distance from the third axis L3 to the second axis L2 is smaller than the vertical distance from the first abutting end 242 to the second axis L2.

The elastic member 32 is disposed between the long rod 23 and the disengagement member 31, so as to maintain the disengagement member 31 at the abutting position. In other words, by use of a resilient pushing force of the elastic member 32, the second abutting end 312 of the disengagement member 31 keeps pressing the first abutting end 242 of the short rod 24. In the embodiment, the elastic member 32 is disposed between the body portion 311 and a groove 234 of the long rod 23, and accordingly abuts against the position between the second abutting end 312 and the support portion 313 of the body portion 311.

The torque adjustment device 40 is disposed on the main body 10, and has a moving seat 41, an adjustment member 42, and a rotating member 43. The moving seat 41 is formed in a rectangular frame shape and slidably disposed in the accommodation space 13 to support the support portion 313 of the disengagement member 31 arranged away from the second abutting end 312. The adjustment member 42 is rotatably disposed between the moving seat 41 and the main body 10 along the fourth axis L4 parallel to the third axis L3. The adjustment member 42 is exposed on the bottom face 15 of the main body 10 and rotationally operatable to drive the moving seat 41 so move along the first axis L1, so as to accordingly change the force with which the second abutting end 312 of the long rod 23 abuts against the short rod 242, thereby adjusting the torque setting value of the mechanical torque wrench 100.

The moving seat 41 comprises an inclined slot 411 having a linear slope and a first toothed portion 412 arranged away from the inclined slot 411. The top face 14 and the bottom face 15 of the main body 10 are disposed along the fourth axis L4, with the inclined slot 411 facing the top face 14, and the adjustment member 42 facing the bottom face 15. The distal end 232 of the long rod 23 extends into the moving seat 41. The support portion 313 of the disengagement member 31 extends into the moving seat 41 and abuts against an inner wall 4111 of the inclined slot 411. The elastic member 32 applies an elastic force to the body portion 311 of the disengagement member 31, so as to keep the support portion 313 in abutment with the inner wall 4111 of the inclined slot 411. Further, the moving seat 41 has a moving slot 413 disposed along a direction parallel to the first axis L1. The first toothed portion 412 is disposed on one side of the inner edge of the moving slot 413. The moving seat 41 has a long slot 414 disposed on one side of the sliding slot 413 along a direction parallel to the first axis L1.

In the embodiment, an assembly hole 415 is disposed between the first toothed portion 412 and the inclined slot 411 and faces the scale hole 141, and a torque indicator 44 is mounted in the assembly hole 415, such that the torque indicator 44 is exposed on the scale hole 141 to indicate the torque scale.

The adjustment member 42 is formed in a disk shape. The adjustment member 42 has a shaft portion 421 passing through the main body 10 and the moving seat 41. A rotating member 43 is mounted around the shaft portion 421 of the adjustment member 42 along the fourth axis L4. The rotating member 43 has a second toothed portion 431 engaged with the first toothed portion 412. The rotational radius of the adjustment member 42 is greater than the rotational radius of the second toothed portion 431, allowing the adjustment member 42 to be conveniently operated to drive the moving seat 41 to move, thereby achieving a rapid adjustment of the torque setting value.

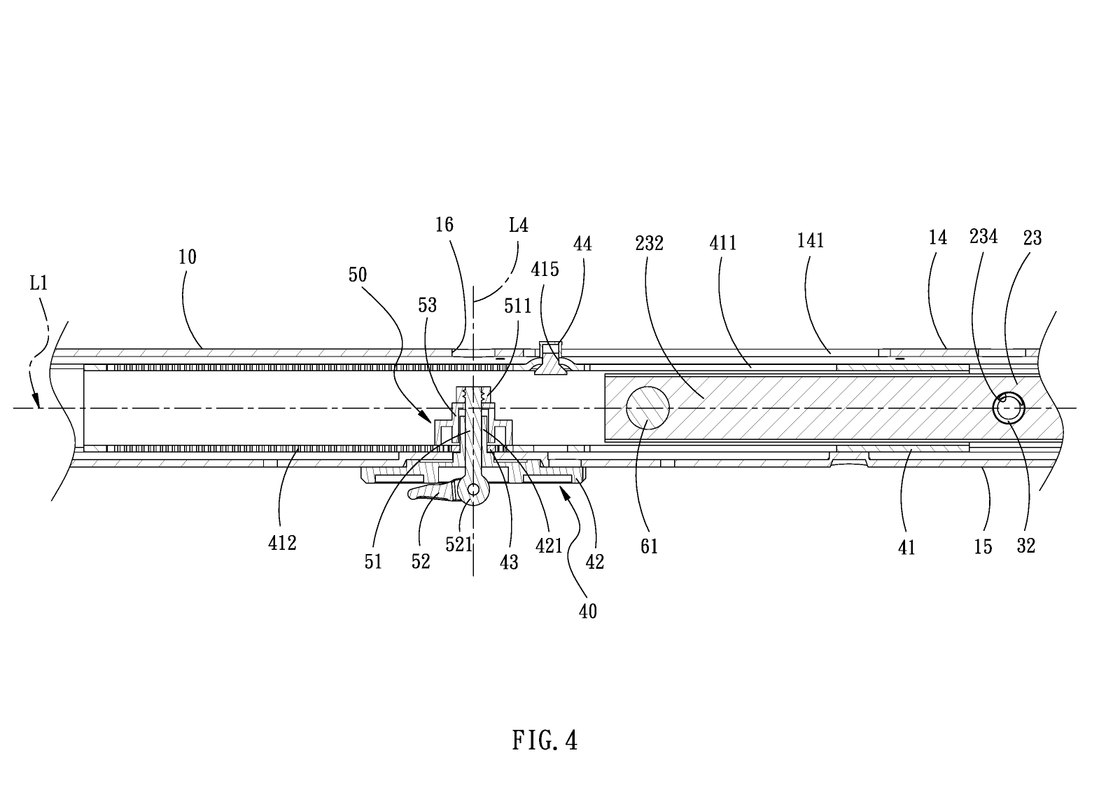

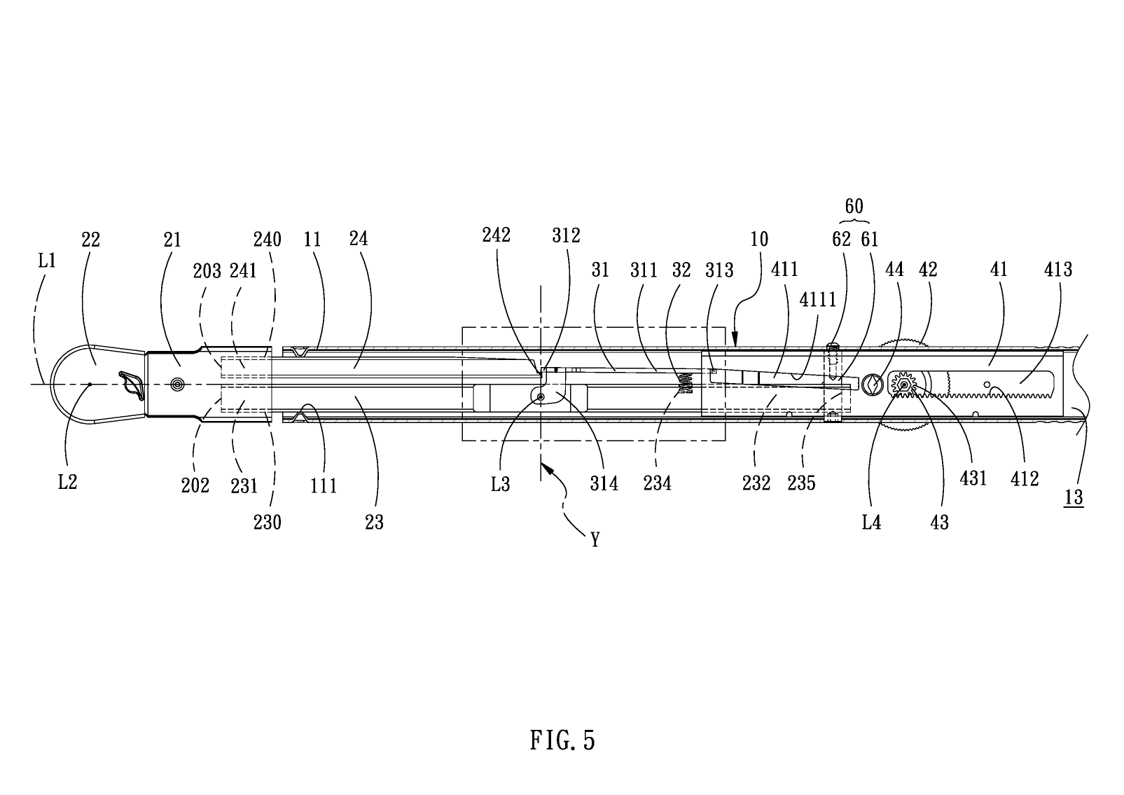

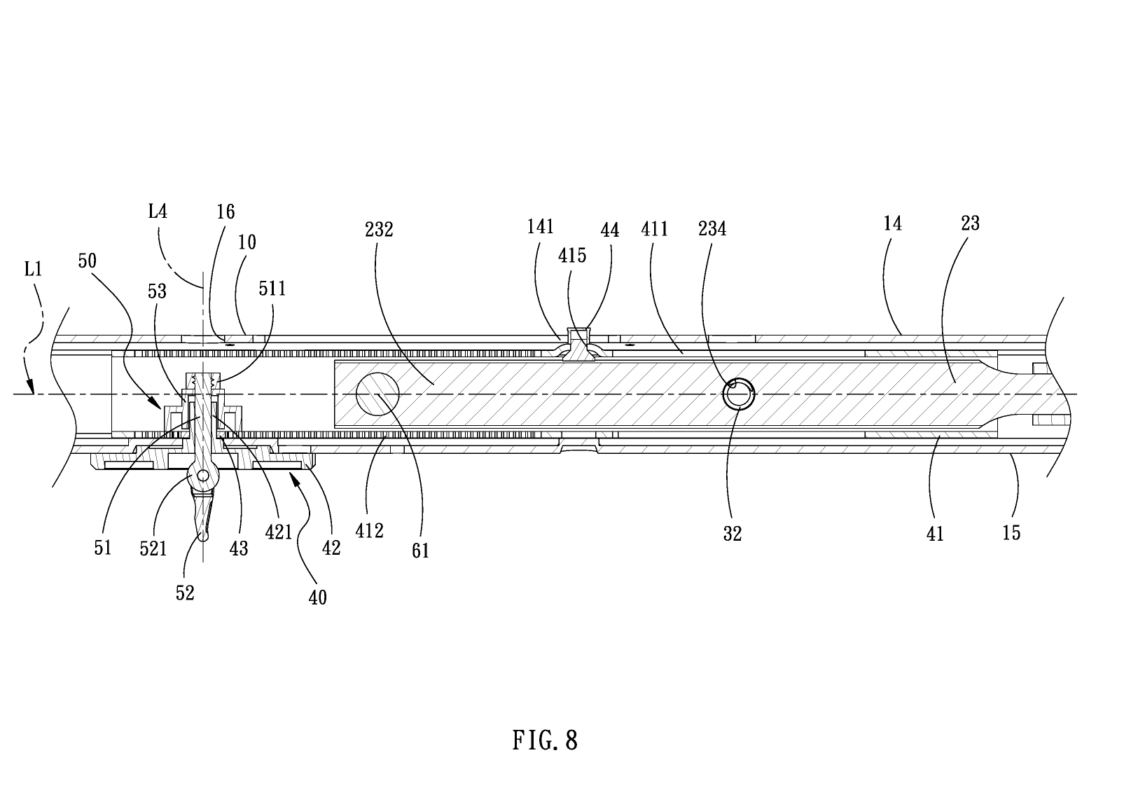

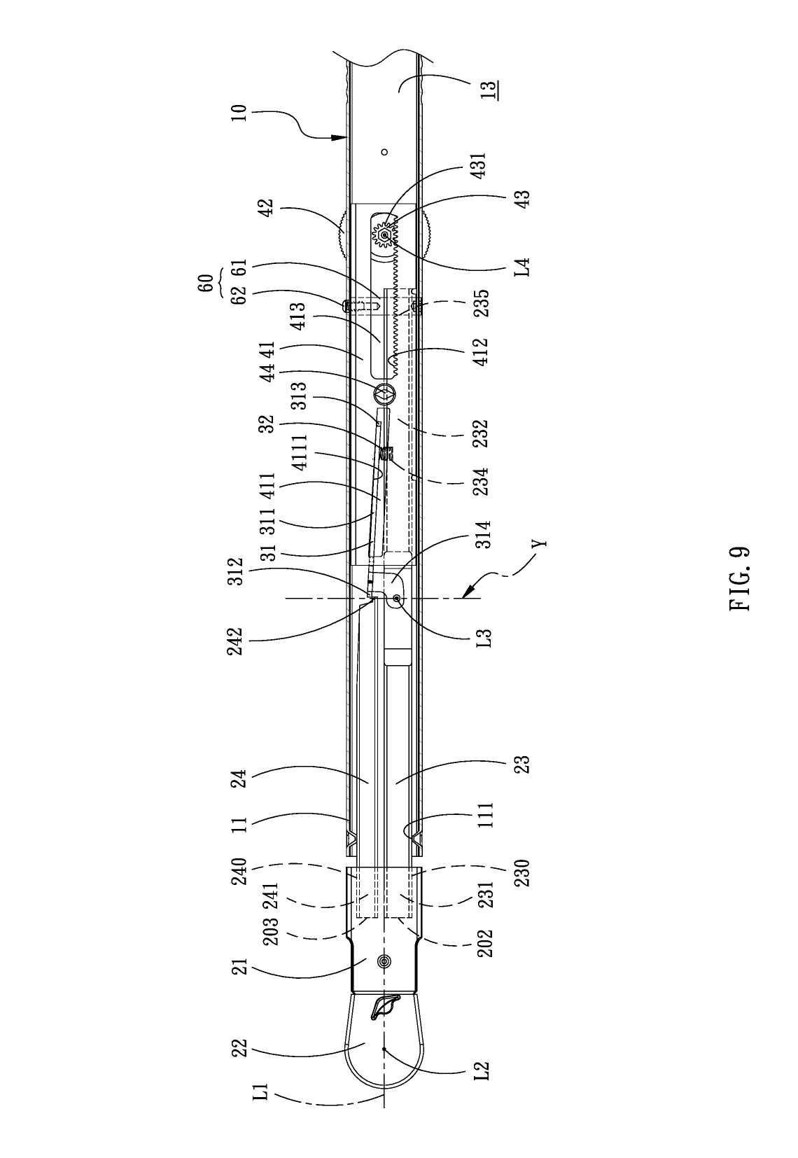

Referring to FIGS. 4 and 8 , in another embodiment, a brake device 50 is disposed between the moving seat 41 and the main body 10. The brake device 50 is operable between a release position and a brake position. Referring to FIGS. 8 and 9 , at the release position, the moving seat 41 is movable to allow the inclined slot 411 to slidably displace with respect to the support portion 313. Referring to FIGS. 4 and 5, at the brake position, the brake device 50 clamps the moving seat 41 and the main body 10 together, so as to prevent the moving seat 41 from moving with respect to the main body 10. With such configuration, during the force application, the mechanical torque wrench 100 is prevented from micro-movement, and the torque is more accurately output prevented from distortion.

The brake device 50 comprises a shaft rod 51, an operation member 52, and a pressing member 53. The shaft rod 51 passes through the position between the main body 10 and the moving seat 41 along the fourth axis L4 and exposed on the bottom face 15 of the main body 10, so as to allow the operation member 52 to be pivotally disposed thereon. Also, the shaft rod 51 has a screw member 511 disposed on one end thereof away from the operation member 52. The penetration hole 16 facilitates screwing the screw member 511 to the shaft rod 51. The operation member 52 has an eccentric cam 521 pivotally disposed on the shaft rod 51, such that the operation member 52 is operable to selectively pivot with respect to the shaft rod 51, thereby driving the shaft rod 51 to move along the fourth axis L4. The pressing member 53 is disposed on one end of the shaft rod 51 away from the operation member 52, and the pressing member 53 is slidably connected with the shaft portion 421 of the adjustment member 42.

At the brake position, the operation member 52 pulls the shaft rod 51 along the fourth axis L4, so that the adjustment member 42 and the pressing member 53 press toward each other, whereby the adjustment member 42 presses the main body 10, and the pressing member 53 is applied with a force by the eccentric cam 521 to press the moving seat 41, thereby clamping the main body 10 and the moving seat 41. At the release position, the operation member 52 is loosened with respect to the shaft rod 51, allowing the adjustment member 42 to be rotationally operated to drive the moving seat 41 to move along the first axis L1 with respect to the main body 10.

In the embodiment, a torque fine adjustment device 60 is disposed between the main body 10 and the long rod 23. The torque fine adjustment device 60 comprises an adjustment screw member 61 and a limiting screw member 62. The adjustment screw member 61 transversely passes through the main body 10, the long groove 414 of the moving seat 41, and a through hole 235 at the distal end 232 of the long rod 23. The limiting screw member 62 passes through the main body 10 to be screwed to the adjustment member 61. With such configuration, the adjustment screw member 61 is operable by a tool to fine adjust the displacement amount of the distal end 232, thereby fine adjusting the torque setting value.

Referring to FIGS. 5-7 , the support portion 313 of the disengagement member 31 abuts against one end of the inclined slot 411 away from the torque indicator 44. At this position, second abutting end 312 of the disengagement member 31 abuts against the first abutting end 242 of the short rod 24 with a larger contact area (compared with FIG. 9), so that the disengagement member 31 abuts against the short rod 24 with a larger force, whereby the torque setting value of the mechanical torque wrench 100 is set at the maximum. Therefore, during the force applying wrenching process, when the torque applied reaches the maxim value, the support portion 313 of the disengagement member 31 is forced to slide along the inclined slot 411 due to the force exceeding its bearing limit. Subsequently, the second abutting end 312 of the disengagement member 31 separates from the first abutting end 242 of the short rod 24, thereby interrupting the torque application of the mechanical torque wrench 100, thereby preventing the over-tightening and potential damage to the bolt or fastener.

Because the second abutting end 312 of the disengagement member 31 does not reach beyond or is approximately flush with the virtual transverse axis Y of the long rod 23, the abutting relationship between the disengagement member 31 and the short rod 24 ends once the torque setting value reaches the preset value without the need for additional components or devices, thereby eliminating additional components and assembly steps thereof.

Referring to FIG. 9, by adjusting the position of the moving seat 41 as aforementioned description, the support portion 313 of the disengagement member 31 is abuts against one end of the inclined slot 411 adjacent to the torque indicator 44. At this position, the disengagement member 31 is positioned at a greater inclination with respect to the first axis L1, such that the second abutting end 312 abuts against the first abutting end 242 of the short rod 24 with a smaller area (compared with FIG. 5. As a result, the force with which the disengagement member 31 abuts against the short rod 24 is reduced, whereby the torque setting value of the mechanical torque wrench 100 is set to its minimum.

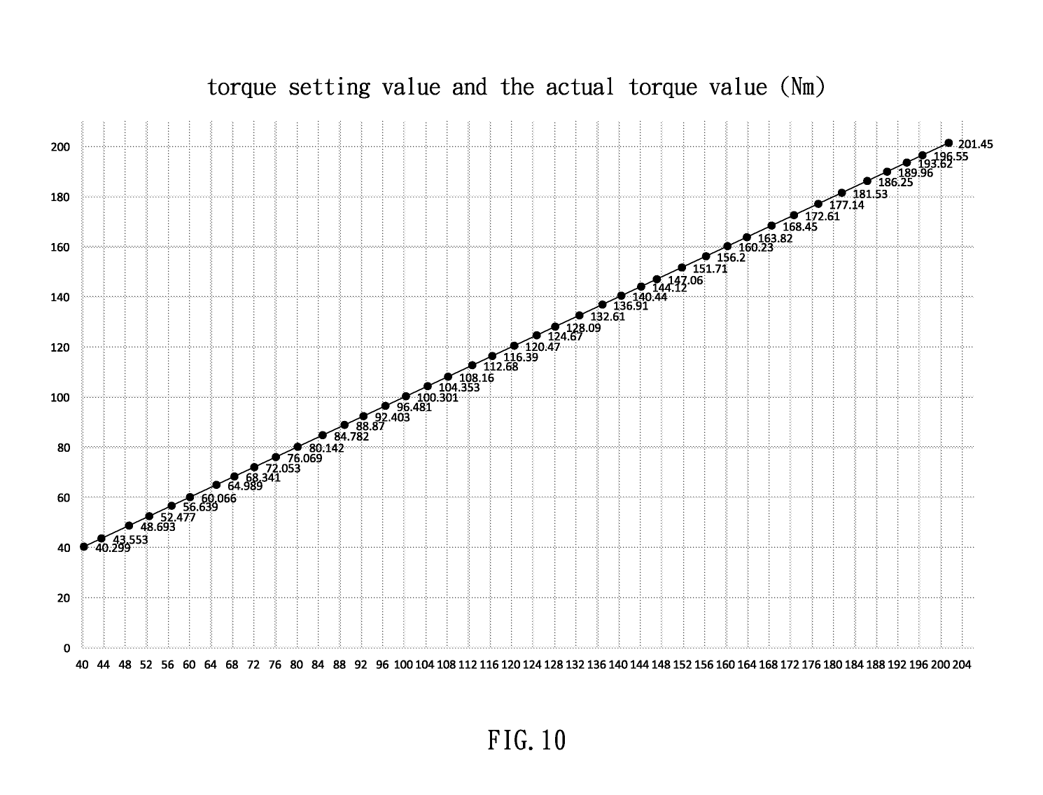

Referring to FIGS. 5, 6, 7, 9, and 10, FIG. fig.10 illustrates a graph showing the relationship between the torque setting value and the actual torque value of the present disclosure. The present disclosure adjusts the torque setting by the movement of the moving seat 41 along the first axis L1 to change the angle of the disengagement member 31. Based on the fact that the inclined slot 411 of the moving seat 41 has a linear slope, the angle of the disengagement member 31 and the position of the moving seat 41 is in a linear relationship. Accordingly, the torque setting value of the present disclosure is closely aligned with the actual torque value, thereby achieving improved torque performance.

In summary, the present disclosure uses a unique abutment structure between the short rod 24 and the disengagement member 31, achieving the disengagement action when the torque reaches the preset value without the need for additional components or devices. Such configuration eliminates the need for extra components and assembly steps thereof, effectively simplifying the structure, thereby not only enhancing the efficiency of precision manufacturing but also facilitating the stability and reliability of the assembly process.

Furthermore, the ear portion 314 of the disengagement member 31 is pivotally mounted in the pivot hole 233 of the long rod 23 using a pin member 315. Accordingly, the disengagement member 31 to pivot with respect to the long rod 23 about the third axis L3. The third axis L3 is perpendicular to the virtual transverse axis Y. The first abutting end 242 of the short rod 24 extends beyond the virtual transverse axis Y; in other words, the first abutting end 242 of the short rod 24 extends beyond the third axis L3. Therefore, the second abutting end 312 of the disengagement member 31 abuts against the first abutting end 242 of the short rod 24, so as to be positioned within the area of the virtual transverse axis Y facing the second end 12 of the main body 10, instead of being within the area of the virtual transverse axis Y facing the first end 11 of the main body 10. The benefit of such configuration is to enhance the sensitivity of the torque disengagement mechanism of the mechanical torque wrench 100 of the present disclosure, providing a sharp disengagement effect.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A mechanical torque wrench, comprising:
a main body having a first end and a second end arranged away from the first end along a first axis, with an accommodation space formed between the first end and the second end;
an actuating device having a driving portion and a long rod and a short rod arranged in opposite to the driving portion, the driving portion being rotatable along a second axis perpendicular to the first axis to drive a fastener, the long rod and the short rod inserted into the accommodation space from the first end, the long rod defining a virtual transverse axis, the short rod having a first abutting end disposed away from the driving portion;
a torque disengagement device disposed between the long rod and the short rod and having a disengagement member, the disengagement member pivotally disposed on the long rod along a third axis parallel to the second axis so as to be swingable between an abutting position and a disengagement position, the third axis arranged perpendicular to the virtual transverse axis, the disengagement member having a second abutting end extending toward the short rod adjacent to the virtual transverse axis to be optionally abutting against the first abutting end; when a force applied by the mechanical torque wrench reaches a preset torque setting value, the second abutting end is disengaged from the first abutting end of the short rod, such that the disengagement member swings from the abutting position to the disengagement position; and
a torque adjustment device disposed on the main body and having a moving seat and an adjustment member, the moving seat slidably disposed in the accommodation space to support an end of the disengagement member away from the second abutting end, the adjustment member rotatably disposed between the moving seat and the main body along a fourth axis parallel to the third axis, the adjustment member exposed on one side of the main body and rotatably operable to drive the moving seat to move along a direction parallel to the first axis, thereby changing a force with which the second abutting end abuts against the first abutting end.

2. The mechanical torque wrench of claim 1, wherein the first abutting end extends beyond the virtual transverse axis, and the second abutting end extends to the virtual transverse axis without crossing the virtual transverse axis; when the disengagement member and the short rod are at the abutting position, a vertical distance from the third axis to the second axis is smaller than a vertical distance from the first abutting end to the second axis.

3. The mechanical torque wrench of claim 2, wherein the moving seat comprises an inclined slot and a first toothed portion arranged away from the inclined slot; the disengagement member has a support portion arranged away from the second abutting end; the support portion extends into the moving seat to abut against the inclined slot; the torque adjustment device has a rotating member connected with the adjustment member along the fourth axis; the rotating member has a second toothed portion engaged with the first toothed portion.

4. The mechanical torque wrench of claim 3, wherein the torque disengagement device comprises an elastic member disposed between the long rod and the disengagement member to keep the support portion abutting to an inner wall of the inclined slot and maintaining the disengagement member at the abutting position; the support portion has an arc shaped sectional face.

5. The mechanical torque wrench of claim 4, wherein the disengagement member has a body portion formed in an elongate plate shape, with the second abutting end disposed at one end of the body portion, and the support portion formed at the other end of the body portion and transversely extending therefrom; the elastic member abuts against a position between the second abutting end and the support portion.

6. The mechanical torque wrench of claim 3, wherein the body comprises a top face and an oppositely disposed bottom face along the fourth axis; the inclined slot faces the top face, and the adjustment member faces the bottom face; the top face of the main body has a scale hole disposed along a direction parallel to the first axis, and the scale hole is in communication with the accommodation space; an assembly hole is disposed between the first toothed portion and the inclined slot and faces the scale hole, and a torque indicator is mounted in the assembly hole; the torque indicator is exposed on the scale hole.

7. The mechanical torque wrench of claim 3, wherein the moving seat is formed in a rectangular frame shape and has a moving slot disposed along a direction parallel to the first axis; the first toothed portion is disposed on one side of an inner edge of the moving slot; the moving seat has a long slot disposed on one side of the sliding slot along the direction parallel to the first axis; the actuating device has an actuating member; the driving portion is removably disposed on one end of the actuating member; the long rod and the short rod are fixed to one end of the actuating member; the long rod has distal end arranged away from the actuating member and extending into the moving seat; a torque fine adjustment device is disposed between the main body and the long rod.

8. The mechanical torque wrench of claim 7, wherein the long rod has a first fixed end arranged away from the distal end; the short rod has a second fixed end arranged away from the first abutting end; the actuating member comprises a first fixing hole and a second fixing hole that are parallel to each other and not in communication; the first fixed end is inserted into the first fixing hole to be positioned therein, and the second fixed end is inserted into the second fixing hole to the positioned therein; each of the first fixing hole, the second fixing hole, the first fixed end, and the second fixed end has a square shaped sectional face.

9. The mechanical torque wrench of claim 8, wherein the first fixing hole comprises four first abutting faces therein, which are interconnected by a first arc groove; the first abutting faces abut against four peripheral sides of the first fixed end; the second fixing hole has four second abutting faces therein, which are interconnected by a second arc groove; the second abutting faces abut against four peripheral sides of the second fixed end.

10. The mechanical torque wrench of claim 3, wherein a brake device is disposed between the moving seat and the main body; the brake device is operable between a release position and a brake position; at the release position, the moving seat is movable for the inclined slot to slidably displace with respect to the support portion; at the brake position, the brake device clamps the moving seat and the main body together, so as to prevent the moving seat from moving with respect to the body.

11. The mechanical torque wrench of claim 10, wherein the body comprises a top face and an oppositely disposed bottom face along the fourth axis; the brake device comprises a shaft rod, an operation member, and a pressing member; the shaft rod passes through a position between the main body and the moving seat along the fourth axis and exposed on the bottom face of the main body with the operation member pivotally disposed thereon; the operation member has an eccentric cam pivotally disposed on the shaft rod, such that the operation member is operable to selectively pivot with respect to the shaft rod, thereby driving the shaft rod to move along the fourth axis; the pressing member is disposed on one end of the shaft rod away from the operation member, and the pressing member is slidably connected with the adjustment member; at the brake position, the operation member pulls the shaft rod along the fourth axis, so that the adjustment member and the pressing member press toward each other, whereby the adjustment member presses the main body, and the pressing member is applied with a force by the eccentric cam to press the moving seat, thereby clamping the main body and the moving seat; at the release position, the operation member is loosened with respect to the shaft rod, allowing the adjustment member to be rotationally operated to drive the moving seat to move along the first axis with respect to the main body.
